(19) United States
(12) Patent Application Publication
(10) Pub. No.: US 2003/0200096 A1
(43) Pub. Date: Oct. 23, 2003

(54) Communication device, communication method, and vehicle-mounted navigation apparatus

(76) Inventor: Masafumi Asai, Tokyo (JP)

Correspondence Address: BIRCH STEWART KOLASCH & BIRCH, PO BOX 747, FALLS CHURCH, VA, 22040-0747, US

(21) Appl. No.: 10/386,419

(22) Filed: Mar. 13, 2003

(30) Foreign Application Priority Data
Apr. 18, 2002 (JP) 2002-116523

(51) Int. Cl. G10L 11/00

(52) U.S. Cl. 704/275

(57) ABSTRACT

A communication device includes a voice command input unit for accepting a voice command spoken by a user, a voice data storage unit for storing the voice command accepted by the voice command input unit as voice data, an electronic mail creating unit for creating an electronic mail including the voice data stored in the voice data storage unit, and an output unit for transmitting the electronic mail created by the electronic mail creating unit.

### BACKGROUND OF THE INVENTION

1. Field of the Invention

The present invention relates to a communication device and a communication method capable of transmitting an electronic mail including an attached voice message. It also relates to a vehicle-mounted navigation apparatus having the communication device.

2. Description of Related Art

Conventionally, a communication device for communicating with equipment disposed outside a vehicle equipped with the communication device employs either a communication method of communicating with the outside equipment by using a mobile telephone or car telephone or a communication method of communicating with the outside equipment by using electronic mails. In accordance with the latter communication method of communicating with the outside equipment by using electronic mails, users are allowed to select characters one by one from a character list displayed on a screen of the communication device so as to create a sentence included in an electronic mail to be transmitted.

Another prior art communication device employs a method of attaching information about the latitude and longitude of the current position of the vehicle acquired from GPS signals to an electronic mail as additional information so as to notify an outside system located outside the vehicle of the vehicle position information, and transmitting the electronic mail to the destination system, so that the destination system can display a map and the vehicle position on the screen thereof using map data stored therein.

However, in accordance with the prior art method of allowing users to select characters one by one from an on-screen character list so as to create a sentence, users should stare at the screen on which the created sentence is shown and therefore cannot create any sentence even with a special device, such as a keyboard, while the vehicle is moving. Therefore, the prior art method has no practical applicability to vehicle-mounted apparatuses.

On the other hand, in accordance with the other prior art method of attaching information about the current position of the vehicle to an electronic mail as additional information, transmitting the electronic mail to a destination system, and allowing the destination system to display a map and the vehicle position on the screen thereof using map data stored therein, since users need some key operations to send the electronic mail to the destination system, the same problem as that encountered with the above-mentioned prior art method arises. Furthermore, when the destination system is communication equipment that is owned by an individual person and that doesn't have any map data on an area in the vicinity of the vehicle position, the destination system cannot display the vehicle position on the screen thereof.

### SUMMARY OF THE INVENTION

The present invention is proposed to solve the above-mentioned problems, and it is therefore an object of the present invention to provide a communication device and a communication method capable of transmitting an electronic mail including an attached voice file to outside equipment so that users are allowed to send a voice command to the outside equipment without any key operations, and a vehicle-mounted navigation apparatus having the communication device.

In accordance with an aspect of the present invention, there is provided a communication device including: a voice command input unit for accepting a voice command spoken by a user; a voice data storage unit for storing the voice command accepted by the voice command input unit as voice data; an electronic mail creating unit for creating an electronic mail including the voice data stored in the voice data storage unit; and an output unit for transmitting the electronic mail created by the electronic mail creating unit.

Therefore, the communication device can allow the user to send an electronic mail including data on a voice command spoken by the user to outside equipment without having to use a special device, such as a keyboard. The communication device according to the present invention that is installed in a vehicle can communication with outside equipment while making it possible for the user to drive the vehicle with safety.

In accordance with another aspect of the present invention, there is provided a communication method including the steps of: accepting a voice command spoken by a user; storing the input voice command as voice data; allowing the user to input a result of determining whether or not the voice data should be transmitted by electronic mail by voice; and transmitting the voice data by electronic mail after performing format conversion on the voice data when the user determines that the voice data should be transmitted by electronic mail.

Therefore, the communication method can allow the user to send an electronic mail including data on a voice command spoken by the user to outside equipment without having to use a special device, such as a keyboard.

In accordance with a further aspect of the present invention, there is provided a vehicle-mounted navigation apparatus including: a voice command input unit for accepting a voice command spoken by a user; a voice data storage unit for storing the voice command accepted by the voice command input unit as voice data; an electronic mail creating unit for creating an electronic mail including the voice data stored in the voice data storage unit; and an output unit for transmitting the electronic mail created by the electronic mail creating unit.

Therefore, the added value of the vehicle-mounted navigation apparatus can be increased.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a communication device according to embodiment 1 of the present invention;

FIG. 2 is a block diagram showing the structure of a vehicle-mounted navigation apparatus according to embodiment 1 of the present invention;

FIG. 3 is a flow chart showing an operation of the communication device according to embodiment 1 of the present invention; and

FIGS. 4A to 4F are diagrams showing display screens produced by the communication device according to embodiment 1 of the present invention.

### DETAILED DESCRIPTION OF THE PREFERRED EMBODIMENT

The invention will now be described with reference to the accompanying drawings.

Embodiment 1.

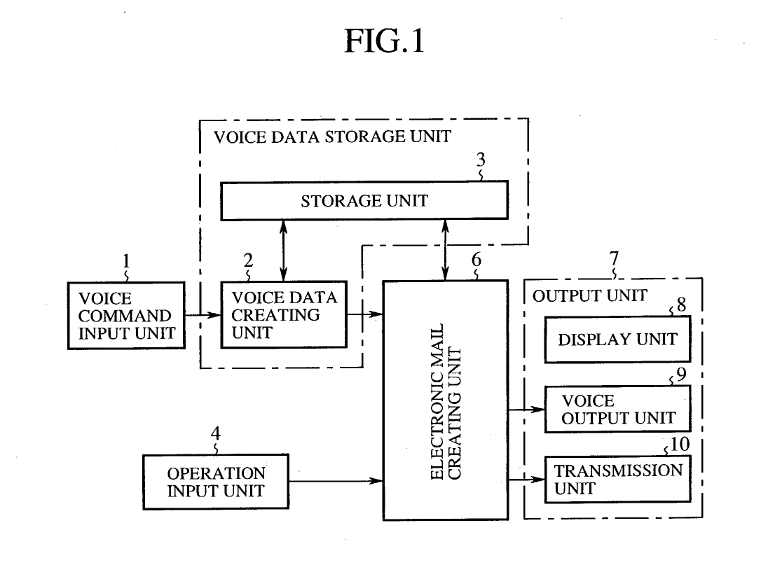

FIG. 1 is a block diagram showing the structure of a communication device according to embodiment 1 of the present invention. In the figure, reference numeral 1 denotes a voice command input unit, reference numeral 2 denotes a voice data producing unit equipped with a compression unit, reference numeral 3 denotes a storage unit, reference numeral 4 denotes an operation input unit, reference numeral 6 denotes an electronic mail creating unit, and reference numeral 7 denotes an output unit including a display unit 8, a voice output unit 9, and a transmission unit 10.

Next, a description will be made as to an operation of the communication device according to embodiment 1 of the present invention. When the voice command input unit 1 accepts a voice command representing start of voice data recording, which is spoken by a user, a voice data storage unit provided with the voice data creating unit 2 and the storage unit 3 starts recording a voice command further spoken by the user and the voice data creating unit 2 stores the voice command in the storage unit 3 as voice data. At this time, the voice data creating unit 2 compresses the voice data. When the voice data creating unit 2 finishes storing the voice data in the storage unit 3, the display unit 8 displays a screen indicating the completion of recording. The display unit 8 then displays a selection screen that allows the user to input a result of determining whether the voice data should be transmitted by electronic mail. The voice output unit 9 outputs voice guidance for inquiring whether the voice data should be transmitted by electronic mail at the same time. When the voice command input unit 1 then accepts “Yes” spoken by the user, the voice data creating unit 2 informs the electronic mail creating unit 6 of the fact that attachment of the voice data to an electronic mail is selected. After converting the voice file (i.e., voice data) compressed and stored in the storage unit 3 into the one having a predetermined format (general format), the electronic mail creating unit 6 attaches the voice file to an electronic mail to be transmitted and sends the electronic mail including the attached voice file to the transmission unit 10. The transmission unit 10 then transmits the electronic mail including the attached voice file to outside equipment disposed outside the communication device.

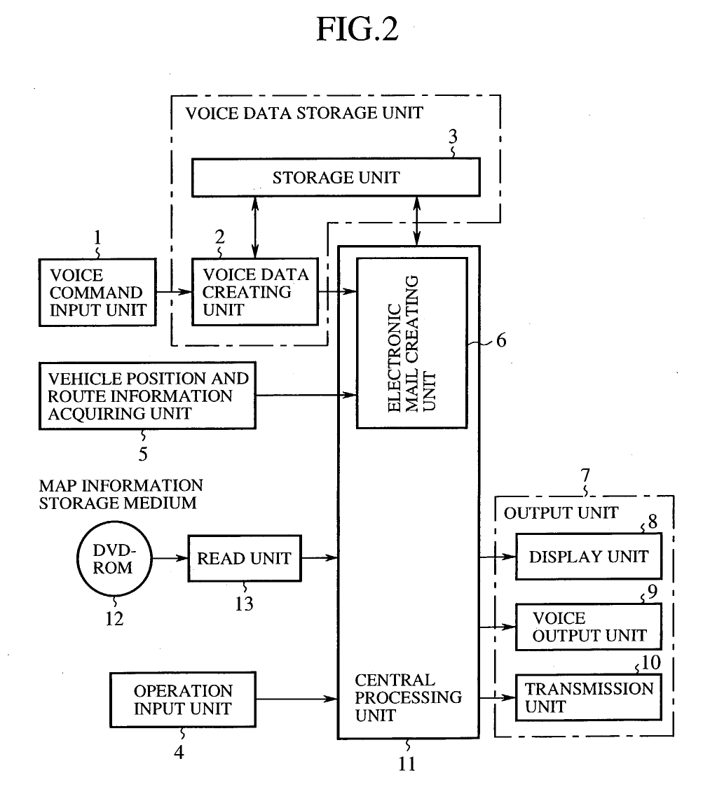

FIG. 2 is a block diagram showing the structure of a vehicle-mounted navigation apparatus having the communication device shown in FIG. 1. The same components as shown in FIG. 1 are designated by the same reference numerals. In FIG. 2, reference numeral 5 denotes a vehicle position and route information acquisition unit, reference numeral 11 denotes a central processing unit provided with the electronic mail creating unit 6, reference numeral 12 denotes a map information storage medium such as a DVD-ROM, and reference numeral 13 denotes a read unit.

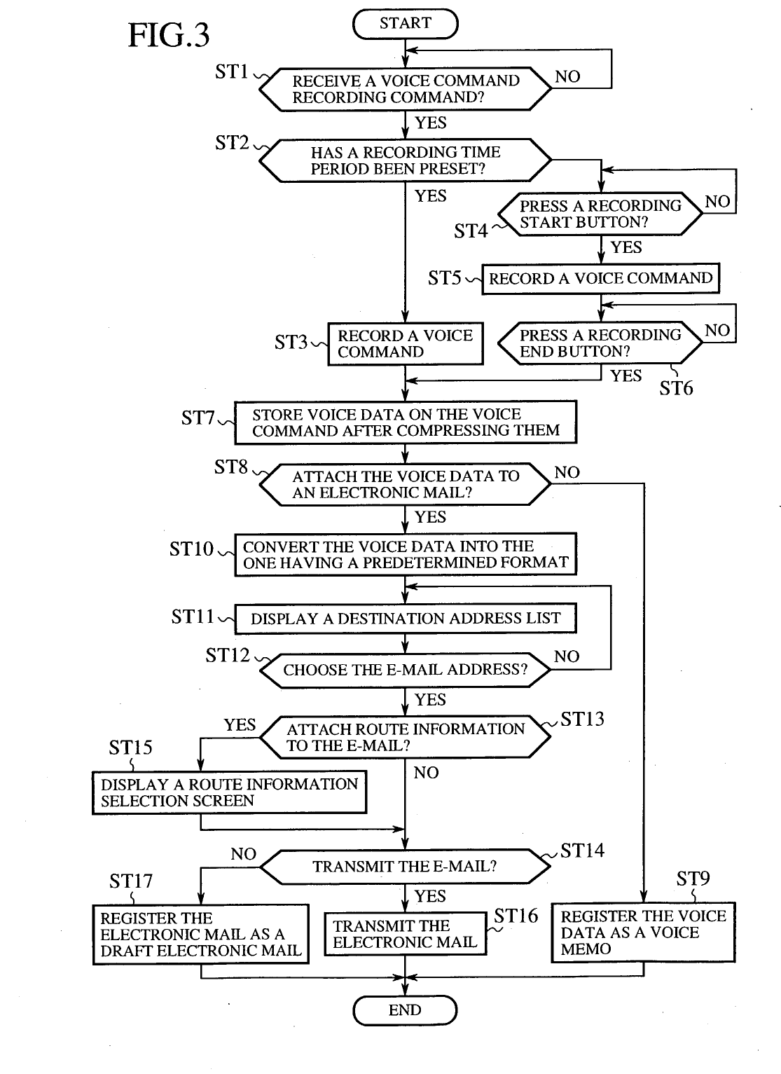

An operation of the vehicle-mounted navigation apparatus will be explained hereafter with reference to the flow chart shown in FIG. 3. When the voice command input unit 1 accepts a voice command representing start of voice data recording that is spoken by a user (in step ST1), after the central processing unit 11 provides voice guidance informing of the start of voice data recording by way of the voice output unit 9, the voice data storage unit starts recording a voice command that will be also spoken by the user. The voice data creating unit 2 determines whether a recording time period has been preset (in step ST2), and accepts and records a voice command that is spoken by the user during the preset time period so as to produce voice data (i.e., a voice file) when the recording time period has been preset (in step ST3). On the other hand, when the recording time period has not been preset, the central processing unit 11 displays a recording start button and a recording end button on the display unit 8 so as to allow the user to press these buttons in succession to record a voice command spoken by the user. The voice data creating unit 2 then, in step ST5, accepts a voice command that is spoken by the user during a time period between the instant when the recording start button is pressed (in step ST4) and the instant when the recording end button is pressed (in step ST6), by way of the voice command input unit 1, and then records the voice command so as to produce voice data.

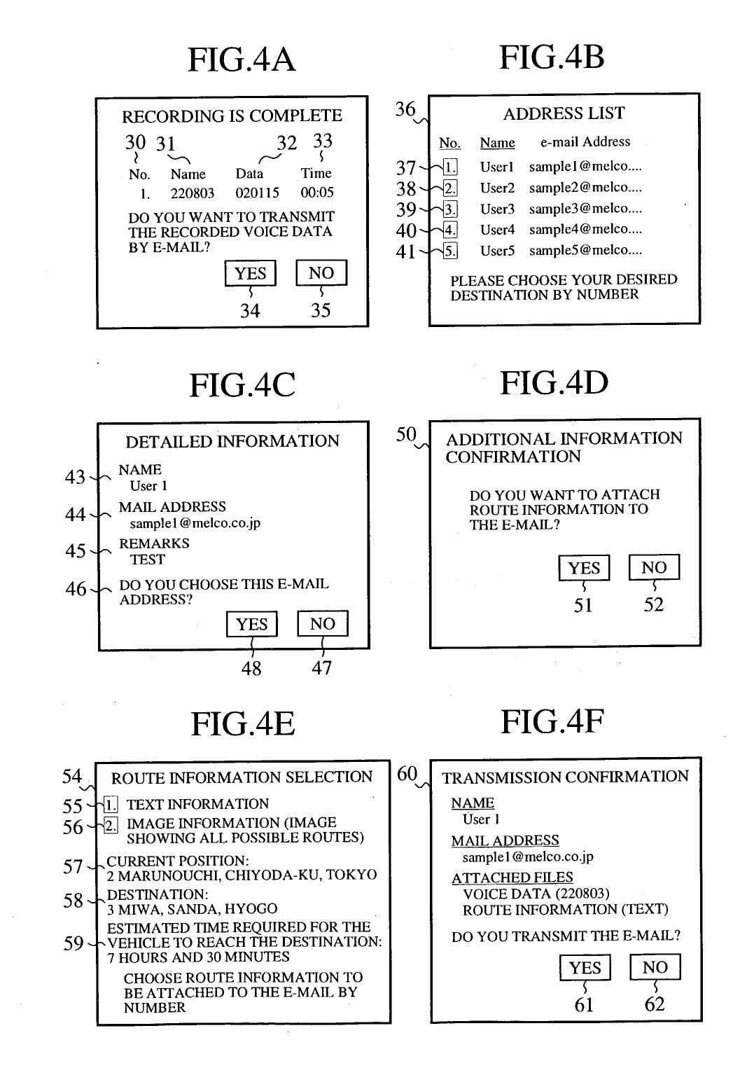

After finishing recording the voice command as voice data, the voice data storage unit compresses and stores the voice data in the storage unit 3 (in step ST7). When the voice data are stored in the storage unit 3, the display unit 8 displays a screen indicating the completion of voice data recording as shown in FIG. 4A (in step ST8). In the example of FIG. 4A, a recording number 30, the name 31 of a party on the other end of communications, the date 32 and time 33 of the recording are displayed on the screen, and buttons 34 and 35 respectively representing “Yes” and “No” are also displayed so that the user can input a result of determining whether the voice data should be transmitted by electronic mail. The voice output unit 9 provides voice guidance that inquires whether the voice data should be transmitted by electronic mail at the same time (in step ST8).

When the user speaks “No” or presses the on-screen button 35 while the screen of FIG. 4A is displayed, the electronic mail creating unit 6 registers the voice data in the storage unit 3 as a voice memo without attaching the voice data to the electronic mail to be transmitted and finishes the electronic mail transmission processing (in step ST9).

In contrast, when the user speaks “Yes” or presses the on-screen button 34 while the screen of FIG. 4A is displayed, the electronic mail creating unit 6 attaches the voice data to the electronic mail after converting the voice file compressed and stored in the voice data storage unit into the one having a predetermined format (in step ST10).

After that, the display unit 8 displays an address list 36 including electronic mail addresses which have been registered in advance, as shown in FIG. 4B (in step ST11), so as to allow the user to choose a desired destination of the created electronic mail. When the user chooses a number showing the desired destination of the electronic mail from the address list 36 and speaks the number, or chooses the corresponding one of the on-screen buttons 37 to 41, the display unit 8 displays detailed information about the chosen number (the on-screen button 37 in this example) as shown in FIG. 4C, for example, a user's name 43, an electronic mail address 44 and remarks 45, and a confirmation message 46 indicating “Do you choose this electronic mail address?” (in step ST12). The voice output unit 9 outputs the following voice message: “Do you choose this electronic mail address?” at the same time.

When the user has chosen a wrong address, he or she can make the display unit 8 display the address list 36, as shown in FIG. 4B, again by speaking “No” or pressing the one-screen button 47 (in step ST11), so that the user is allowed to choose the desired destination of the created electronic mail again (in step ST12). When the user speaks “Yes” or presses the on-screen button 48 after choosing the address of the desired destination, the display unit 8 displays an additional information confirmation screen 50, as shown in FIG. 4D, that allows the user to further attach route information to the electronic mail, and the voice output unit 9 outputs the following voice message: “Do you want to attach route information to the electronic mail?” at the same time. The user is thus allowed to determine whether or not route information should be attached to the electronic mail (in step ST13). When the user does not desire attachment of any route information to the electronic mail and then speaks “No” or presses the on-screen button 52, the electronic mail creating unit 6 advances to step ST 14 in which it attaches only the recorded voice data to the electronic mail and delivers the electronic mail to the transmission unit 10 when the user desires to transmit the electronic mail to the destination.

In contrast, when the user speaks “Yes” or presses the on-screen button 51 while the screen 50 of FIG. 4D is displayed, the display unit 8 displays a route information selection screen 54, as shown in FIG. 4E, which allows the user to choose route information about the route to the destination (in step ST15). The voice output unit 9 provides the following voice guidance: “Choose route information to be attached to the electronic mail by number” at the same time. The user can choose either text information or image information (e.g., an image showing all possible routes) as the route information that is to be added to the created electronic mail by pressing an on-screen button 55 or 56.

When the user chooses, as the route information, text information by pressing the on-screen button 55, the electronic mail creating unit 6 adds the name 57 of the current position, the name 58 of the destination, the distance between the current position and the destination and the estimated time of arrival 59 (or the estimated time required for the vehicle to arrive at the destination) which are written in text form to the main body of the electronic mail.

On the other hand, when the user chooses, as the route information, image information by pressing the on-screen button 56, the display unit 8 displays a map having an appropriate scale, showing all possible routes, and including the vehicle position and the destination, and the electronic mail creating unit 6 attaches image data on the map image including the name 57 of the current position, the name 58 of the destination, the distance between the current position and the destination and the estimated time of arrival 59 (or the estimated time required for the vehicle to arrive at the destination) to the electronic mail as an attached file.

After the electronic mail creating unit 6 sets all attached files, the display unit 8 displays a transmission confirmation screen 60 as shown in FIG. 4F and the voice output unit 9 provides the following voice guidance: “Transmit the electronic mail?” at the same time, so that the user can check to see whether there are errors in the input information (in step ST14). When the user speaks “No” or presses an on-screen button 62 while the screen 60 is displayed, the electronic mail creating unit 6 stops creating the electronic mail and stores the electronic mail being created as a draft electronic mail in the storage unit 3 (in step ST17). In contrast, when the user determines that there is no error in the created electronic mail after checking the contents of the electronic mail and then speaks “Yes” or presses an on-screen button 61, the electronic mail creating unit 6 delivers the electronic mail having the fixed contents and including the attached voice file and so on to the transmission unit 10 and the transmission unit 10 transmits the electronic mail to the predetermined destination (in step ST16).

As mentioned above, the communication device in accordance with the present invention includes a voice command input unit for accepting a voice command spoken by a user, a voice data storage unit for storing the voice command accepted by the voice command input unit as voice data, an electronic mail creating unit for creating an electronic mail including the voice data stored in the voice data storage unit, and an output unit for transmitting the electronic mail created by the electronic mail creating unit. Therefore, the communication device can allow the user to send an electronic mail including data on a voice command spoken by the user to outside equipment without having to use a special device, such as a keyboard. The communication device according to the present invention that is installed in a vehicle can communication with outside equipment while making it possible for the user to drive the vehicle with safety. The communication device can also transmit information about the current position of the vehicle to such a destination system as communication equipment that is owned by an individual person and that doesn't have any map data on an area in the vicinity of the vehicle position so that the destination system can display the vehicle position on a screen thereof. When the communication device according to the present invention is applied to a vehicle-mounted navigation apparatus, the added value of the vehicle-mounted navigation apparatus can be increased. Needless to say that the communication device can be free standing.

In addition, because a voice data creating unit compresses and stores the voice data in the storage unit, thereby reducing the amount of the voice file. Furthermore, because the electronic mail creating unit converts the voice data into the one having a predetermined format when attaching the voice data to the electronic mail, the communication device enables the destination system to reproduce the voice command regardless of the type of the destination system. In addition, because the electronic mail creating unit can further attach either route information about a route to the destination or vehicle position information to the electronic mail including the attached voice data so that the destination system can display the vehicle position on a screen thereof even though the destination system doesn't have any map data on an area in the vicinity of the vehicle position.

Many widely different embodiments of the present invention may be constructed without departing from the spirit and scope of the present invention. It should be understood that the present invention is not limited to the specific embodiments described in the specification, except as defined in the appended claims.

What is claimed is:

1. A communication device comprising:
a voice command input means for accepting a voice command spoken by a user;
a voice data storage means for storing the voice command accepted by said voice command input means as voice data;
an electronic mail creating means for creating an electronic mail including the voice data stored in said voice data storage means; and
an output means for transmitting the electronic mail created by said electronic mail creating means.

2. The communication device according to claim 1, wherein said voice data storage means stores the voice data after compressing them.

3. The communication device according to claim 1, wherein said electronic mail creating means creates the electronic mail including the voice data after performing format conversion on the voice data stored in said voice data storage means.

4. A communication method comprising the steps of:
accepting a voice command spoken by a user;
storing the input voice command as voice data;
allowing the user to input a result of determining whether or not the voice data should be transmitted by electronic mail by voice; and
transmitting the voice data by electronic mail after performing format conversion on the voice data when the user determines that the voice data should be transmitted by electronic mail.

5. A vehicle-mounted navigation apparatus that searches for an optimum route from a place of departure to a destination, said apparatus comprising:
a voice command input means for accepting a voice command spoken by a user;
a voice data storage means for storing the voice command accepted by said voice command input means as voice data;
an electronic mail creating means for creating an electronic mail including the voice data stored in said voice data storage means; and
an output means for transmitting the electronic mail created by said electronic mail creating means.

6. The vehicle-mounted navigation apparatus according to claim 5, wherein said electronic mail creating means includes a means for attaching route information about the route or vehicle position information about a current position of a vehicle to the electronic mail including the voice data as an attached file.
